(19) United States
(12) Patent Application Publication
(10) Pub. No.: US 2025/0239782 A1
(43) Pub. Date: Jul. 24, 2025

(54) PHASED ARRAY ANTENNA MODULE WITH LOADED METAMATERIALS,RF CIRCUITRY, AND 5G MOBILE DEVICE

(71) Applicant: HUIZHOU SPEED WIRELESS TECHNOLOGY CO., LTD., HUIZHOU (CN)

(72) Inventors: GUANNAN TAN, HUIZHOU (CN); QINFANG LI, HUIZHOU (CN)

(73) Assignee: HUIZHOU SPEED WIRELESS TECHNOLOGY CO., LTD., HUIZHOU (CN)

(21) Appl. No.: 19/033,513

(22) Filed: Jan. 22, 2025

Related U.S. Application Data
(63) Continuation of application No. PCT/CN2023/122715, filed on Sep. 28, 2023.

(51) Int. Cl. H01Q 15/00; H01Q 3/26

(52) U.S. Cl. CPC H01Q 15/0086; H01Q 3/2676

(57) ABSTRACT

The present disclosure provides a phased array antenna module loaded with metamaterials, an RF circuit, and a 5G mobile device. The module includes a millimeter-wave RF module with at least one emission surface and an arc-shaped metamaterial structure featuring multiple stacked layers, each with periodically distributed metallic unit structures. Each concave surface of the metamaterial structure aligns with the corresponding emission surface, and the metallic unit structures in the same layer are of equal size. Across layers, these structures are arranged in a one-to-one correspondence, with sizes sequentially increasing or decreasing along the stacking direction. This configuration improves gain, expands scanning angles, and minimizes scanning loss, offering enhanced performance and seamless integration with modern 5G devices.

### TECHNICAL FIELD

The present disclosure relates to the field of communications, and more particularly to a phased array antenna module loaded with metamaterials, radio frequency (RF) circuitry, and a 5G mobile device.

### BACKGROUND

As a new generation of mobile communication networks, 5G aims not only to facilitate communication between people, offering users immersive experiences such as augmented reality, virtual reality, and ultra-high-definition video, but also to address communication between people and objects and between objects. This enables applications like mobile healthcare, connected vehicles, smart homes, industrial control, and environmental monitoring in the Internet of Things (IoT). 5G is expected to permeate various industries, becoming a key infrastructure for the digital, networked, and intelligent transformation of economic and social systems.

The transmission of millimeter-wave signals is particularly challenging. Due to their high-frequency nature, millimeter waves exhibit greater path loss and weaker diffraction capabilities, making them easily obstructed. Consequently, millimeter waves cannot be applied directly in 5G mobile devices without compensation. To overcome these challenges, millimeter waves must achieve very high gain during application. Traditional millimeter-wave antenna modules include millimeter-wave RF modules and metamaterial structures. Metamaterials are artificially engineered materials with unique properties not found in nature, enabling special control over the amplitude and phase of transmitted and reflected waves. Factors such as the transmission coefficient, incident angle of electromagnetic waves, and the refractive index of the dielectric material play significant roles, with the effective permittivity of metamaterials being less than or equal to zero. Metamaterials can converge incident spherical waves into planar beams in the transmission direction, thereby enhancing far-field gain. Additionally, they can achieve wide-angle scanning by controlling the phase of transmitted waves.

However, as the integration of electronic devices increases, the size of millimeter-wave modules used for communication between 5G mobile devices and servers has decreased, leading to a corresponding reduction in the size of phased array antenna modules loaded with metamaterials. For instance, Chinese Patent CN216251089U discloses a combination antenna of a millimeter-wave RF module loaded with a planar metamaterial structure. Similarly, Chinese Patent CN114824832A discloses a high-gain millimeter-wave patch antenna array. Both designs require substantial spatial installation areas. Moreover, as the size of phased array antenna modules loaded with metamaterials decreases, the radiation aperture of such modules also diminishes. This reduction in size leads to lower gain for the modules, thereby narrowing the phase scanning angle of the corresponding phased array antenna module loaded with metamaterials.

### SUMMARY

Accordingly, there is a need to provide a phased array antenna module loaded with metamaterials, RF circuitry, and a 5G mobile device to address the issues of low gain and narrow phase scanning angles in conventional phased array antenna modules loaded with metamaterials.

A phased array antenna module loaded with metamaterials comprises: a millimeter-wave RF module configured with at least one millimeter-wave emission surface; and an arc-shaped metamaterial structure, wherein the arc-shaped metamaterial structure includes at least one arc-shaped concave surface, each of which is aligned with a corresponding millimeter-wave emission surface; each arc-shaped metallic pattern layer consists of multiple periodically distributed metallic unit structures, with multiple arc-shaped metamaterial structures being stacked. The metallic unit structures in each arc-shaped metallic pattern layer within the same arc-shaped metamaterial structure are of equal size; the metallic unit structures of each arc-shaped metallic pattern layer in the multiple arc-shaped metamaterial structures are arranged in a one-to-one correspondence. These metallic unit structures are stacked layer by layer, with each metallic unit structure in adjacent arc-shaped metamaterial structures increasing or decreasing sequentially in size along the stacking direction.

An RF circuit includes any of the aforementioned embodiments of the phased array antenna module loaded with metamaterials.

A 5G mobile device includes a housing and any of the aforementioned embodiments of the RF circuit, wherein both the millimeter-wave RF module and the arc-shaped metamaterial structure are fixed within the housing.

Compared to prior art, the present disclosure offers the following advantages, among others:

1. the phased array antenna module loaded with metamaterials enhances the gain in the vertical direction (0 degrees) due to the refractive characteristics of the metamaterial structure. The arc-shaped metamaterial structure features at least one arc-shaped concave surface, each aligned with a corresponding millimeter-wave emission surface. During beam scanning, obliquely incident waves are vertically incident onto the arc-shaped surface of the metamaterial structure. Vertical incidence minimizes wave loss, and compared to planar metamaterial structures, the arc-shaped metamaterial structure increases both the gain and the scanning angle of the phased array antenna module loaded with metamaterials. This configuration reduces scanning loss for the phased array antenna module loaded with metamaterials.

2. both the millimeter-wave RF module of the RF circuit and the arc-shaped metamaterial structure can be fixed within the housing. The arc-shaped metamaterial structure, featuring at least one arc-shaped concave surface, better matches the external structural shape of the housing for 5G mobile devices. Consequently, the phased array antenna requires less space for the same gain performance. This enhances the suitability of the phased array antenna module loaded with metamaterials for the increasing integration of electronic products.

### BRIEF DESCRIPTION OF THE DRAWINGS

To better illustrate the technical solutions of the embodiments or the prior art described in this disclosure, a brief introduction to the figures used in the descriptions of the embodiments or prior art is provided below. It should be noted that the figures described below are merely some examples of embodiments of this disclosure. For those skilled in the art, additional figures for other embodiments may be obtained based on these figures without any creative effort.

FIG. 1 illustrates a schematic diagram of a phased array antenna module loaded with metamaterials according to one embodiment.

FIG. 2 provides another perspective view of the phased array antenna module loaded with metamaterials shown in FIG. 1.

FIG. 3 shows an exploded view of the phased array antenna module loaded with metamaterials depicted in FIG. 1.

FIG. 4 presents a schematic diagram of the scanning angle of the phased array antenna module loaded with metamaterials illustrated in FIG. 1.

FIG. 5 depicts a schematic diagram of another embodiment of a phased array antenna module loaded with metamaterials.

FIG. 6 shows an exploded schematic diagram of the phased array antenna module loaded with metamaterials illustrated in FIG. 5.

FIG. 7 illustrates a schematic diagram of yet another embodiment of a phased array antenna module loaded with metamaterials.

FIG. 8 shows an exploded view of the phased array antenna module loaded with metamaterials depicted in FIG. 7.

FIG. 9 provides a schematic diagram of another embodiment of a phased array antenna module loaded with metamaterials.

FIG. 10 illustrates a schematic diagram of yet another embodiment of a phased array antenna module loaded with metamaterials.

FIG. 11 shows an exploded view of the phased array antenna module loaded with metamaterials illustrated in FIG. 10.

FIG. 12 presents a schematic diagram of a further embodiment of a phased array antenna module loaded with metamaterials.

FIG. 13 provides a partial schematic diagram of the phased array antenna module loaded with metamaterials illustrated in FIG. 12.

FIGS. 14 to 21 respectively show various forms of metallic unit structures of the arc-shaped metallic pattern layers in the arc-shaped metamaterial structures of the phased array antenna module loaded with metamaterials.

FIG. 22 illustrates a schematic diagram of a 5G mobile device according to one embodiment.

FIG. 23 presents a schematic diagram of another embodiment of a 5G mobile device.

FIG. 24 depicts a schematic diagram of yet another embodiment of a phased array antenna module loaded with metamaterials.

FIG. 25 shows a radiation pattern on the phi=90-degree plane of a 1×4 phased array antenna module loaded with metamaterials and an arc-shaped metamaterial structure according to one embodiment.

FIG. 26 illustrates a radiation pattern on the phi=90-degree plane of a traditional 1×4 phased array antenna module loaded with planar metamaterial structures.

FIG. 27 depicts a three-dimensional radiation pattern covered by a 1×4 phased array antenna module loaded with metamaterials according to one embodiment.

FIG. 28 illustrates a three-dimensional radiation pattern covered by a traditional 1×4 phased array antenna module loaded with planar metamaterial structures.

### DETAILED DESCRIPTION

To facilitate understanding of the present disclosure, a more comprehensive description of the disclosure will be provided with reference to the relevant figures. The figures presented herein represent preferred embodiments of the disclosure. However, the disclosure is not limited to the embodiments described and can be implemented in various forms. The purpose of these embodiments is to make the content of the disclosure clearer and more complete.

It should be noted that when a component is described as being “fixed to” another component, it may be directly fixed on the other component or involve an intermediate element. Similarly, when a component is described as being “connected” to another component, it may be directly connected or include intermediate elements. Terms such as “vertical,” “horizontal,” “left,” and “right” are used for explanatory purposes and do not imply exclusivity to any specific embodiment. Unless otherwise defined, all technical and scientific terms used herein have the meanings commonly understood by those skilled in the technical field of the present disclosure. The terms used in this disclosure are intended to describe particular embodiments and are not meant to limit the scope of the disclosure. The term “and/or” includes any and all combinations of the listed items.

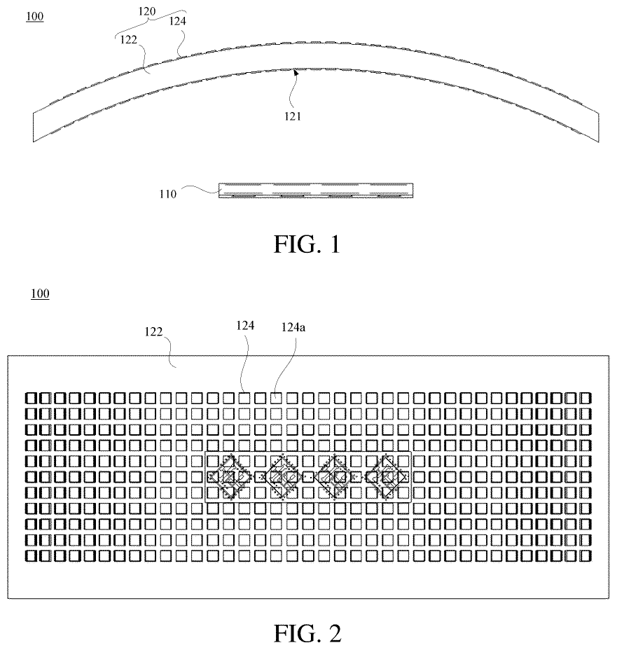

As shown in FIGS. 1 to 3a, one embodiment of a phased array antenna module loaded with metamaterials (100) includes a millimeter-wave RF module (110) and an arc-shaped metamaterial structure (120). The millimeter-wave RF module (110) is configured with at least one millimeter-wave emission surface. The arc-shaped metamaterial structure (120) includes at least one arc-shaped concave surface (121), with each arc-shaped concave surface aligned with a corresponding millimeter-wave emission surface. When performing beam scanning, obliquely incident waves become vertically incident onto the arc-shaped surface of the metamaterial structure. Since vertically incident waves have minimal loss, the arc-shaped metamaterial structure increases both the gain and scanning angle of the phased array antenna module, reducing scanning loss compared to planar metamaterial structures. Each arc-shaped concave surface, aligned with its corresponding millimeter-wave emission surface, converges the spherical waves generated by the millimeter-wave RF module (110) into planar beams, enhancing far-field gain and enabling wide-angle scanning through phase control of the transmitted waves. Additionally, the arc-shaped metamaterial structure (120) aligns with the contour of the housing (200).

The phased array antenna module loaded with metamaterials (100) benefits from the refractive characteristics of the metamaterial structure, specifically its non-positive effective permittivity, enhancing the gain in the vertical direction (0 degrees). With at least one arc-shaped concave surface, each aligned with a corresponding millimeter-wave emission surface, the arc-shaped metamaterial structure minimizes loss for vertically incident waves. Compared to planar metamaterial structures, the arc-shaped metamaterial structure increases both gain and scanning angles, thereby reducing scanning loss. The millimeter-wave RF module (110) and the arc-shaped metamaterial structure (120) can both be fixed within the housing (200). The arc-shaped metamaterial structure (120), with its concave surface, aligns well with the contour of the 5G mobile device housing (200), reducing the spatial requirements for similar gain performance and better accommodating the integration needs of modem electronic devices.

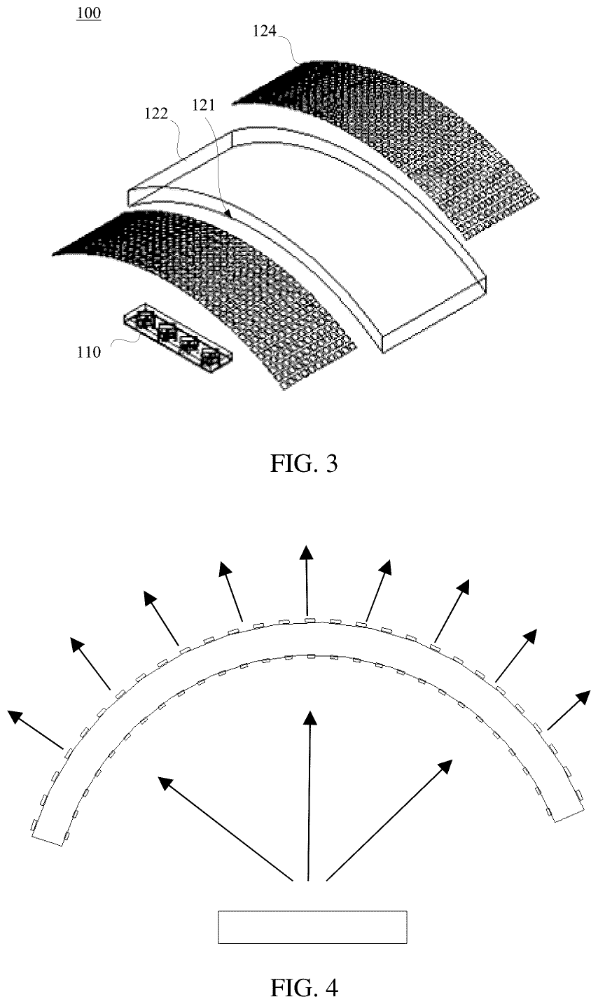

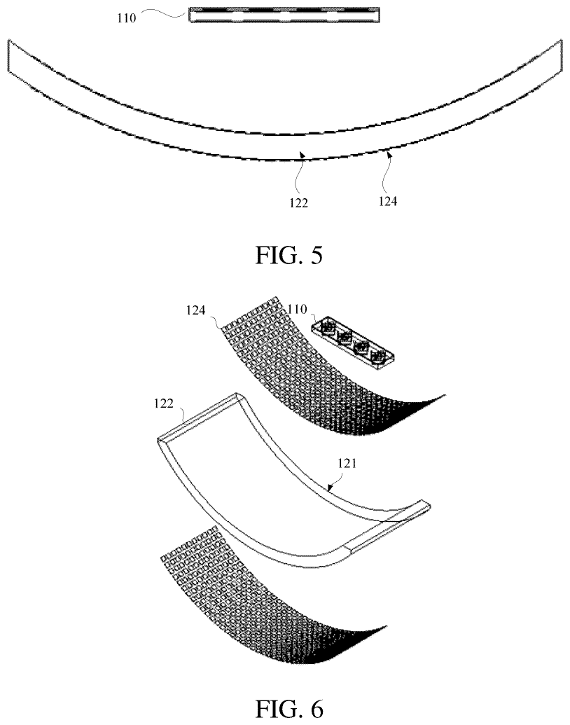

As shown in FIGS. 1 and 3, in one embodiment, the arc-shaped metamaterial structure (120) includes an arc-shaped dielectric substrate (122) and two arc-shaped metallic pattern layers (124). One metallic pattern layer (124) is formed on one side of the dielectric substrate (122), while the other metallic pattern layer (124) is formed on the opposite side. Thus, the two metallic pattern layers (124) are located on opposite sides of the dielectric substrate (122). In another embodiment, the arc-shaped dielectric substrate (122) and the two metallic pattern layers (124) are integrally formed, ensuring a compact structure and reliable fixation of the metallic pattern layers (124) to the dielectric substrate (122). Specifically, the arc-shaped metamaterial structure (120) consists of an arc-shaped dielectric substrate (122) and two metallic pattern layers (124) conformally formed on its front and back sides. FIG. 2 provides a top-down view of the phased array millimeter-wave antenna module loaded with the arc-shaped metamaterial structure (120). It should be noted that the arc-shaped concave surface (121) is not limited to upward convex concave structures but can also be downward convex concave structures, as shown in FIGS. 4 and 5.

In one embodiment, each arc-shaped metallic pattern layer (124) is formed on the arc-shaped dielectric substrate (122) using processes such as Laser-Direct Structuring (LDS), Flexible Printed Circuit (FPC), Liquid Crystal Polymer (LCP), Modified Polyimide (MPI), ceramic, or metallic mesh techniques. For example, each arc-shaped metallic pattern layer (124) may be a flexible material layer adhered to the arc-shaped dielectric substrate (122). Furthermore, each arc-shaped metallic pattern layer (124) can first be semi-finished using MPI, LCP, or FPC processes, followed by metallic pattern drawing. Semi-finished products may include flexible substrate material layers or thin-film material layers.

It is understood that in other embodiments, each arc-shaped metallic pattern layer (124) is not limited to being initially semi-finished using MPI, LCP, or FPC processes. For instance, each arc-shaped metallic pattern layer (124) may alternatively be formed as an arc-shaped metallic layer using a metallic mesh process. Each arc-shaped metallic pattern layer (124) may not be limited to flexible material layers; they can also be metallic mesh structural layers, such as copper or aluminum mesh structural layers.

In one embodiment, the number of arc-shaped dielectric substrates (122) is multiple, with the substrates stacked. Each layer of metamaterial structure can be designed for different frequencies, increasing the gain, scanning angle, and bandwidth of the phased array antenna module loaded with metamaterials.

In one embodiment, the multiple arc-shaped dielectric substrates (122) are laminated to reliably secure the stacked connection. In this embodiment, the multiple arc-shaped dielectric substrates (122) are laminated through a pressing process.

In one embodiment, each arc-shaped dielectric substrate (122) is made from at least one material selected from plastic, ceramic, or glass. The materials of adjacent arc-shaped dielectric substrates (122) may be the same or different. In this embodiment, adjacent arc-shaped dielectric substrates (122) use the same material, with each substrate made from plastic. In other embodiments, adjacent substrates may use different materials.

In one embodiment, the number of arc-shaped metallic pattern layers (124) is multiple, further increasing the gain of the phased array antenna module loaded with metamaterials (100) and thus enhancing its scanning angle while reducing scanning loss.

As shown in FIGS. 2 and 3, in one embodiment, each arc-shaped metallic pattern layer (124) comprises multiple periodically distributed metallic unit structures (124a). Specifically, each arc-shaped metallic pattern layer (124) forms a rectangular array of metallic unit structures (124a) distributed on the arc-shaped plane. The uniform distribution of metallic unit structures (124a) ensures consistent refractive indices and transmission coefficients across all positions of the phased array antenna module loaded with metamaterials (100).

It is understood that in other embodiments, the metallic unit structures (124a) of each arc-shaped metallic pattern layer (124) are not limited to rectangular arrays. As shown in FIGS. 6 to 8a, for instance, the metallic unit structures (124a) may be arranged in a circular array on the arc-shaped plane. Specifically, the metallic unit structures (124a) may form M concentric circular distributions, where M is an integer greater than or equal to 1, and the number of metallic unit structures (124a) in each circle varies. Furthermore, the spacing between the metallic unit structures (124a) in each circular distribution may also vary. Additionally, the spacing of metallic unit structures (124a) within the same circular distribution may be unequal, allowing flexible configuration based on practical requirements.

In one embodiment, the size of each metallic unit structure (124a) ranges from 1/15 λ to 1/10 λ, enabling the phased array antenna module loaded with metamaterials (100) to achieve a better refractive index. Due to the arc-shaped metamaterial structure (120) having at least one arc-shaped concave surface, each concave surface aligns with the corresponding millimeter-wave emission surface. This configuration reduces the effective incidence angle for oblique electromagnetic waves and increases the corresponding transmission coefficient, thereby enabling the phased array antenna module loaded with metamaterials (100) to achieve a wider scanning angle.

In one embodiment, the spacing between adjacent metallic unit structures (124a) ranges from 1/10 λ to ⅕ λ, ensuring a better transmission coefficient for the phased array antenna module loaded with metamaterials (100). The arc-shaped metamaterial structure (120), with its concave surfaces aligned with the millimeter-wave emission surfaces, reduces the effective incidence angle for oblique electromagnetic waves, further enhancing the transmission coefficient and expanding the scanning angle of the phased array antenna module loaded with metamaterials (100).

It should be noted that the size of the metallic unit structures (124a) corresponds to different refractive indices, while the spacing of the metallic unit structures (124a) corresponds to different transmission coefficients. For oblique electromagnetic wave incidence, larger incidence angles result in lower transmission coefficients. The arc-shaped dielectric substrate (122), with its arc-shaped structure, reduces the effective incidence angle and increases the transmission coefficient, further expanding the scanning angle of the phased array antenna module loaded with metamaterials (100).

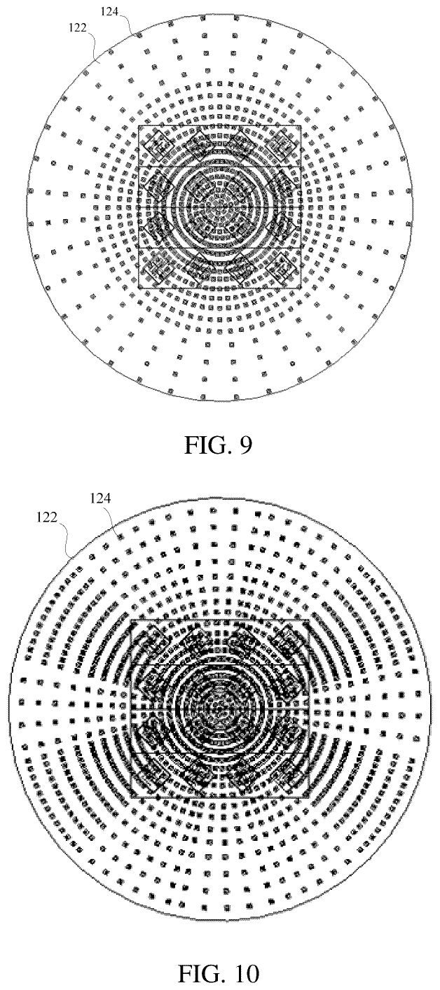

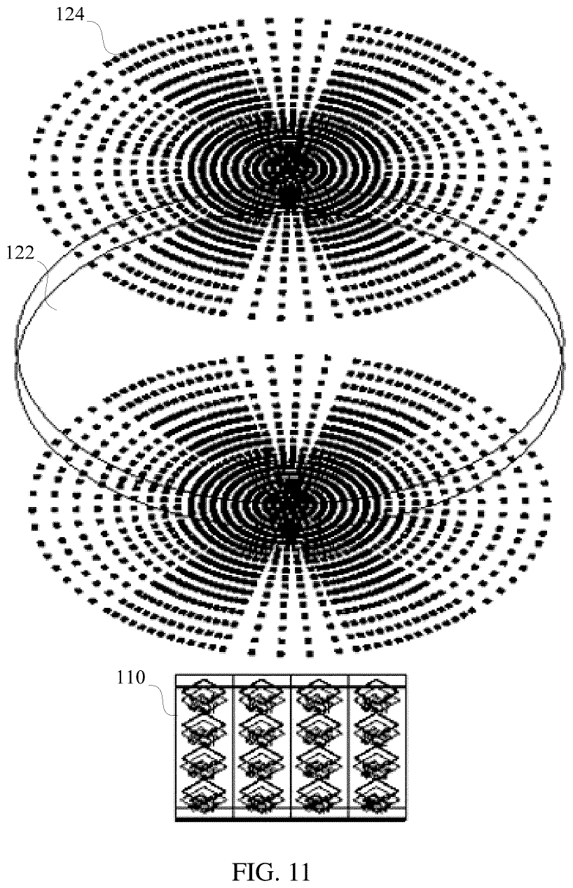

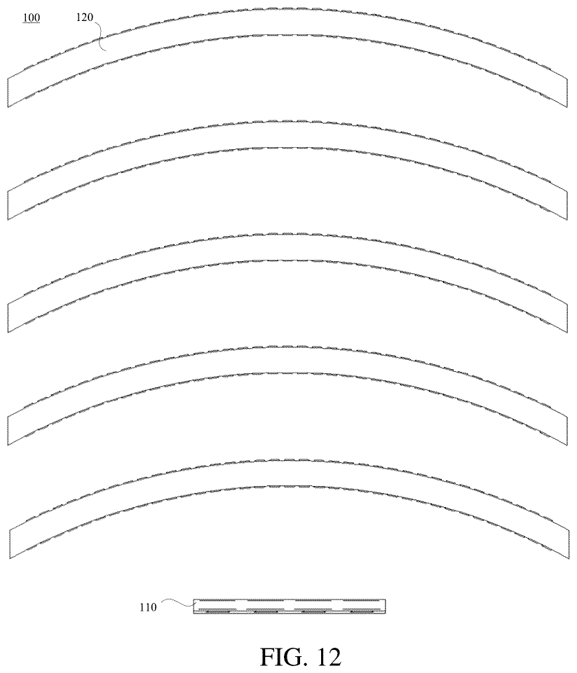

As shown in FIGS. 9 and 10, in one embodiment, multiple arc-shaped metamaterial structures (120) are stacked, where one arc-shaped metallic pattern layer (124) of an arc-shaped metamaterial structure (120) is stacked and in contact with the metallic pattern layer (124) of another arc-shaped metamaterial structure (120). This configuration increases the gain of the phased array antenna module loaded with metamaterials (100). The arc-shaped metamaterial structure (120), with at least one concave surface aligned with the millimeter-wave emission surface, minimizes wave loss for vertically incident waves, thereby increasing the gain and scanning angle of the phased array antenna module loaded with metamaterials (100) while reducing scanning loss compared to planar metamaterial structures.

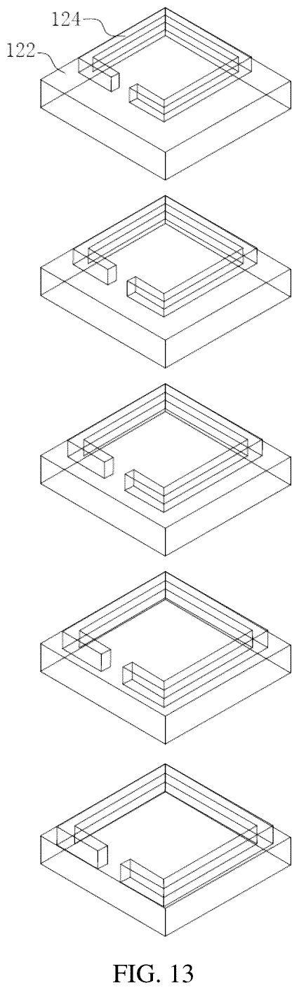

As shown in FIG. 13, which provides a partial view of the arc-shaped dielectric substrate with metallic unit structures (124a), in one embodiment, the size of each metallic unit structure (124a) varies between layers. Specifically, the size of each metallic unit structure (124a) in one arc-shaped metallic pattern layer (124) differs from that in an adjacent layer. The variation in metallic unit structure sizes corresponds to different refractive indices, enabling broader phase angle coverage and wider scanning angles for the phased array antenna module loaded with metamaterials (100).

In this embodiment, the size of the metallic unit structures (124a) in the same arc-shaped metallic pattern layer (124) remains uniform, while the sizes of metallic unit structures (124a) across different arc-shaped metamaterial structures (120) vary. This configuration allows the phased array antenna module loaded with metamaterials (100) to achieve multiple phase angles and wider scanning coverage.

In an alternative embodiment, the size of each metallic unit structure (124a) within a single layer may remain constant across all layers. This consistent sizing still contributes to improved performance of the phased array antenna module loaded with metamaterials (100), although it may result in slightly narrower scanning coverage compared to configurations with varied metallic unit structure sizes.

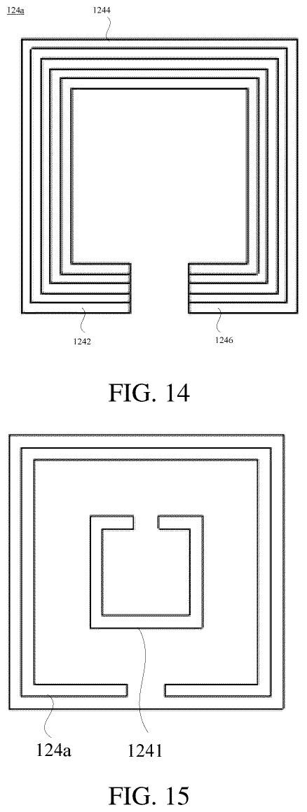

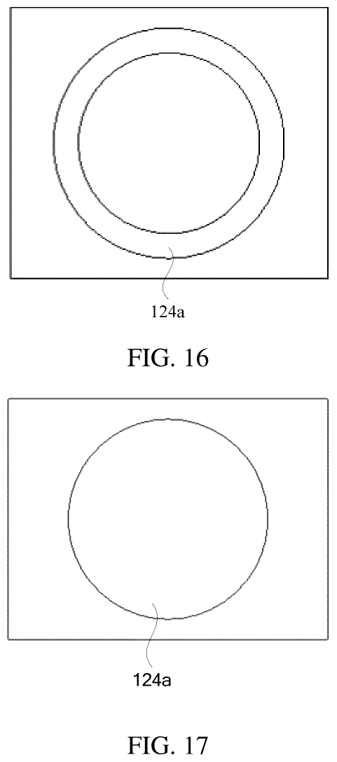

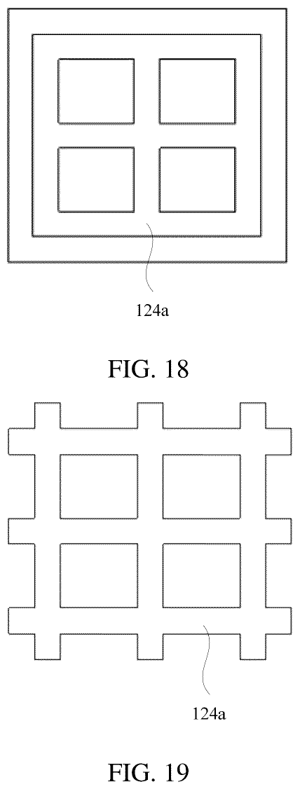

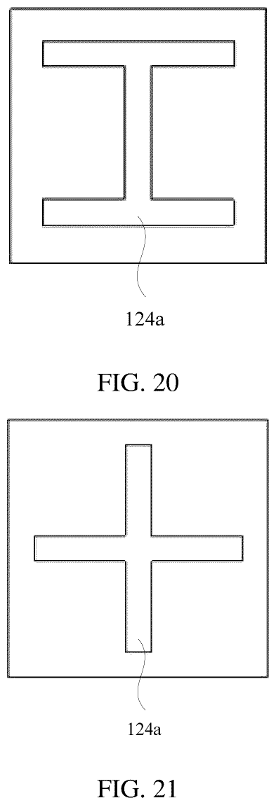

As shown in FIG. 14, in one embodiment, each metallic unit structure (124a) has a bent shape comprising a first end (1242), a bent connection portion (1244), and a second end (1246) connected in sequence. The bent connection portion forms a U-shape, creating a semi-enclosed raised rib structure that enhances the refractive angle of each metallic unit structure (124a). In this embodiment, each metallic unit structure (124a) includes one bent connection portion.

It is understood that in other embodiments, the bent connection portion is not limited to a single instance. For example, as shown in FIG. 15, the bent connection portion may comprise two segments, with adjacent ends connected and their openings offset. Additionally, each metallic unit structure (124a) may consist of two sub-structures (1241), each including a first end, a bent connection portion, and a second end, where one sub-structure surrounds the other. Furthermore, metallic unit structures (124a) are not limited to open configurations; they can adopt shapes such as rings, circles, rectangles, or grids. Metallic unit structures (124a) may also take forms like I-shapes or cross-shapes.

In one embodiment, the arc-shaped metamaterial structure (120) comprises multiple layers of arc-shaped dielectric substrates (122) and metallic pattern layers (124). The dielectric substrates (122) may serve as the housing (200) for the 5G mobile device (10) and may be made of materials such as plastic, ceramic, or glass. Each metallic pattern layer (124) in the arc-shaped metamaterial structure (120) can be formed using processes such as LDS, FPC, LCP, MPI, ceramic, or metallic mesh.

In one embodiment, the metallic pattern layers (124) are created using a metallic mesh process, resulting in metallic mesh components made from materials like copper or aluminum. Alternatively, flexible substrate materials such as MPI, LCP, FPC, or transparent thin-film materials can be used. These materials are etched with metallic patterns and then attached to the surface of the dielectric substrate (122).

As shown in FIG. 12 and FIG. 13, in one embodiment, the arc-shaped metamaterial structure (120) employs five layers of metallic patterns. The sizes of the metallic unit structures (124a) in each layer vary, corresponding to different refractive indices and transmission coefficients. This configuration enables wide phase-angle coverage and broad scanning angles.

In this embodiment, both the number of millimeter-wave emission surfaces and concave surfaces is one. However, in other embodiments, multiple emission and concave surfaces may be used, with each concave surface aligned with a corresponding emission surface. This alignment minimizes wave loss for vertically incident waves, thereby increasing the gain and scanning angles of the phased array antenna module loaded with metamaterials (100) while reducing scanning loss.

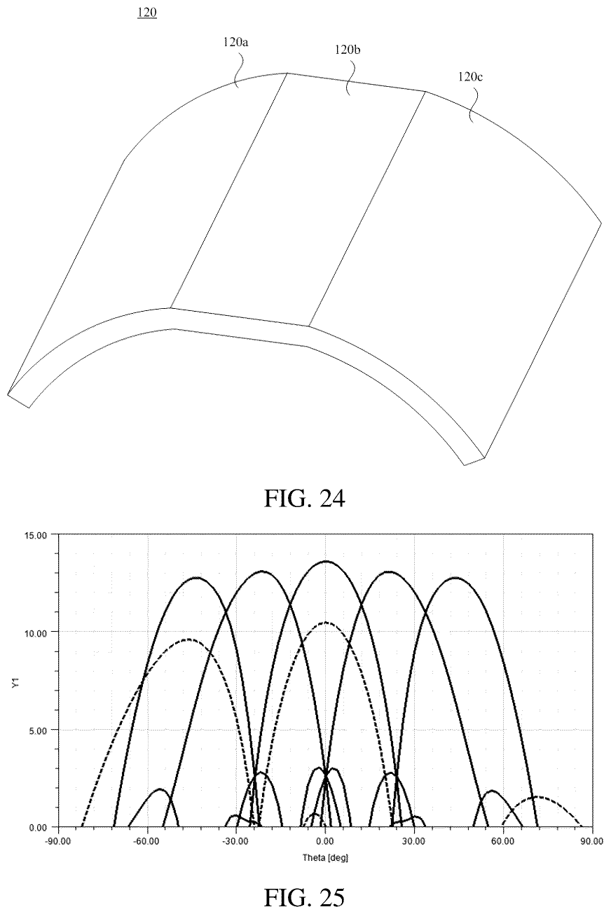

As shown in FIG. 24, in one embodiment, the arc-shaped metamaterial structure (120) adopts a wave-like shape, enhancing the scanning angle and further reducing scanning loss. This design also improves the adaptability of the phased array antenna module loaded with metamaterials (100).

Further, the wave-like arc-shaped metamaterial structure (120) comprises a first arc-shaped surface section (120a), a central flat section (120b), and a second arc-shaped surface section (120c) connected sequentially. The first and second arc-shaped surface sections are symmetrically connected to opposite sides of the central flat section. This structure enables the millimeter-wave RF module (110) to converge spherical waves into planar beams in the transmission direction, increasing far-field gain. By controlling the phase of the transmitted waves, wide-angle scanning is achieved, thereby enhancing the gain and scanning angles of the phased array antenna module loaded with metamaterials (100) while reducing scanning loss. In this embodiment, both arc-shaped surface sections curve towards the same side of the central flat section.

Further, in one embodiment, the millimeter-wave RF module (110) is a 5G millimeter-wave phased array RF module QTM525 or QTM527, enabling the phased array antenna module loaded with metamaterials (100) to effectively transmit RF signals. It is understood that in other embodiments, the millimeter-wave RF module (110) is not limited to QTM525 or QTM527. For example, it can also be a 60 GHz WiGig RF module, a 60 GHz radar gesture recognition module, or a dielectric resonator antenna RF module.

The present disclosure also provides an RF circuit, including the phased array antenna module loaded with metamaterials (100) in any of the above-described embodiments. In one embodiment, the phased array antenna module loaded with metamaterials (100) includes a millimeter-wave RF module (110) and an arc-shaped metamaterial structure (120). The millimeter-wave RF module (110) has at least one millimeter-wave emission surface. The arc-shaped metamaterial structure (120) forms at least one arc-shaped concave surface, with each arc-shaped concave surface aligned with a corresponding millimeter-wave emission surface. This arrangement enables the spherical waves generated by the millimeter-wave RF module (110) to converge into planar beams in the transmission direction, enhancing far-field gain. The metamaterials, by controlling the phase of the transmitted waves, achieve wide-angle scanning while ensuring compatibility between the arc-shaped metamaterial structure (120) and the housing (200).

The described RF circuit utilizes the refractive characteristics of the metamaterial structure to enhance gain in the 0-degree vertical direction of the phased array antenna module loaded with metamaterials (100). The arc-shaped metamaterial structure forms at least one arc-shaped concave surface, with each concave surface aligned with the corresponding millimeter-wave emission surface. When performing beam scanning, oblique incident waves are vertically incident on the arc-shaped surface, minimizing loss. Compared to planar metamaterial structures, the arc-shaped metamaterial structure increases both gain and scanning angle while reducing scanning loss. Both the millimeter-wave RF module (110) and the arc-shaped metamaterial structure (120) are securely fixed within the housing (200). The arc-shaped metamaterial structure (120), with its concave surfaces, aligns well with the housing shape of a 5G mobile device (10), minimizing the required space for equivalent gain performance and improving compatibility with the increased integration of electronic products.

In one embodiment, the operating frequency band of the phased array antenna module loaded with metamaterials (100) is 10 GHz to 300 GHz. The arc-shaped metamaterial structure (120), with at least one arc-shaped concave surface aligned with the corresponding millimeter-wave emission surface, ensures excellent gain and scanning angle, further meeting the integration demands of modem electronic products.

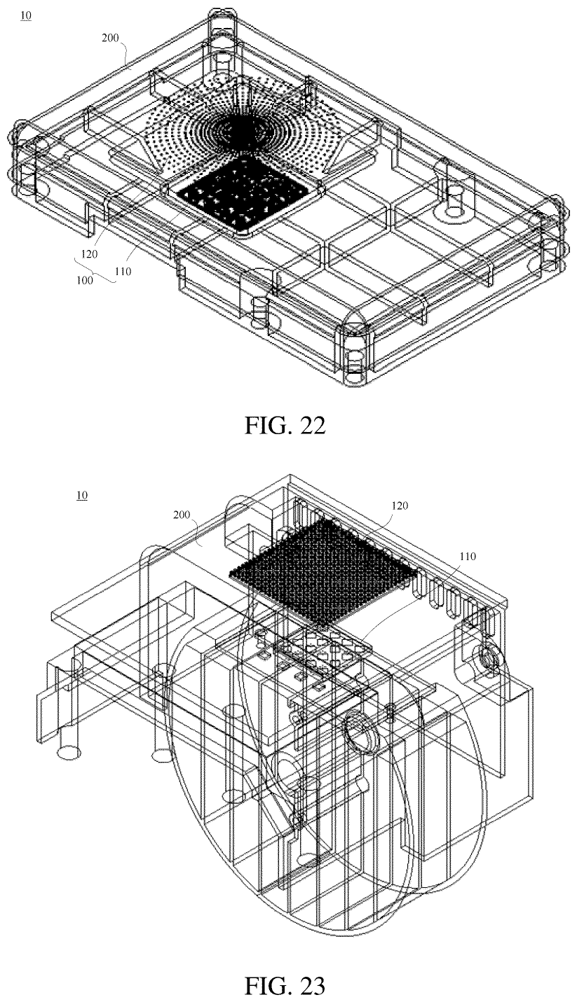

As shown in FIG. 22, the present disclosure also provides a 5G mobile device (10), including a housing (200) and the RF circuit described above. The millimeter-wave RF module (110) and the arc-shaped metamaterial structure (120) are securely fixed within the housing (200). In one embodiment, the RF circuit includes the phased array antenna module loaded with metamaterials (100), which comprises a millimeter-wave RF module (110) and an arc-shaped metamaterial structure (120). The millimeter-wave RF module (110) has at least one millimeter-wave emission surface, and the arc-shaped metamaterial structure (120) forms at least one arc-shaped concave surface, with each concave surface aligned with the corresponding millimeter-wave emission surface. This arrangement enables the spherical waves generated by the millimeter-wave RF module (110) to converge into planar beams, enhancing far-field gain, achieving wide-angle scanning through phase control, and aligning the arc-shaped metamaterial structure (120) with the housing (200).

In this 5G mobile device (10), the millimeter-wave RF module (110) and arc-shaped metamaterial structure (120) are securely fixed within the housing (200). The refractive characteristics of the metamaterial structure enhance the gain in the 0-degree vertical direction of the phased array antenna module loaded with metamaterials (100). The arc-shaped metamaterial structure forms at least one arc-shaped concave surface aligned with the corresponding millimeter-wave emission surface. This configuration minimizes loss for vertically incident waves, increases both gain and scanning angle, and reduces scanning loss compared to planar metamaterial structures. The secure fixation of the millimeter-wave RF module (110) and arc-shaped metamaterial structure (120) within the housing (200) ensures alignment with the housing shape, reducing the required space for equivalent gain performance and enhancing compatibility with the increasing integration of electronic products.

It can be understood that, in one embodiment, a 5G mobile device may include a mobile terminal, CPE (Customer Premise Equipment), a micro base station, or remote system wireless equipment.

As shown in FIGS. 12 and 13, in one embodiment, the millimeter-wave RF module (110) can be positioned at various locations within the housing (200), such as on the top (FIG. 22) or the side (FIG. 23) of the 5G mobile device (10). The arc-shaped metamaterial structure (120) is loaded directly above the radiation direction of the antenna array of the RF module. This structure includes an arc-shaped dielectric substrate (122) and an arc-shaped metallic pattern layer (124) formed on the substrate. The dielectric substrate (122) can be a single layer or multiple layers laminated together using identical or different materials. Similarly, the metallic pattern layer (124) can consist of single or multiple layers.

In one embodiment, the millimeter-wave RF module (110) can be arc-shaped or planar to adapt to the conformal phased array RF module structure. The arc-shaped metamaterial structure (120) is compatible with conformal phased array RF module configurations, enhancing the gain of the phased array antenna module loaded with metamaterials and broadening the scanning angle. Compared to conventional planar metamaterial structures, the disclosed design achieves better applicability, wider scanning angles, and higher gain, resulting in a broader coverage range for the phased array antenna module.

In one embodiment, structural fixtures protrude within the housing (200), securing the millimeter-wave RF module (110) and the arc-shaped metamaterial structure (120). A preset gap is maintained between the two components. Alternatively, support columns installed within the housing (200) can secure the RF module (110) and the metamaterial structure (120). This configuration ensures stability while maintaining the necessary spatial arrangement.

The arc-shaped metamaterial structure (120) is particularly suited to the curved housing (200) of communication products. Unlike planar metamaterial structures that must be centrally positioned—often resulting in limited antenna directionality and susceptibility to environmental interference—the arc-shaped design improves radiation characteristics, mitigates interference, and allows optimal antenna placement.

Further, the thickness of the arc-shaped metamaterial structure at the center of the concave surface is greater than that at the edges, creating a thicker center and thinner edges. This distribution enhances bandwidth and enables the metamaterial structure to function over a broader frequency range.

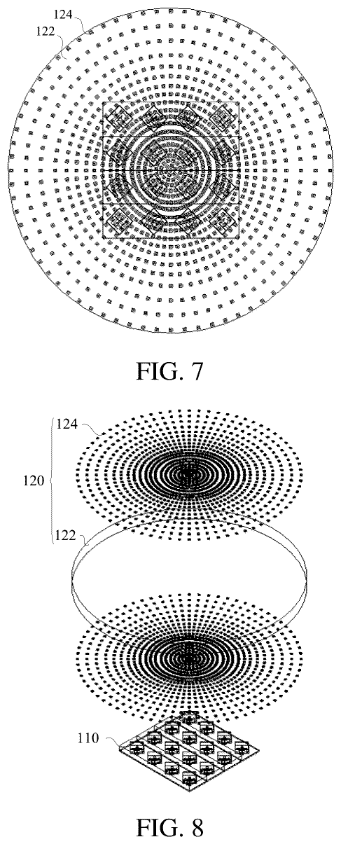

As shown in FIG. 7 and FIG. 8, in one embodiment, the arc-shaped metamaterial structure is positioned directly above the millimeter-wave module with a spacing (h) ranging from approximately ¼ λ to 1.2λ. The RF module and metamaterial structure can be secured using support columns or internal components of the 5G mobile device (10). The metallic pattern layer (124) can be fabricated through processes such as PCB, LDS, FPC, LCP, MPI, ceramics, or metallic mesh, with materials like copper or aluminum for metallic mesh structures. Alternatively, flexible substrate materials such as MPI, LCP, or FPC can be used.

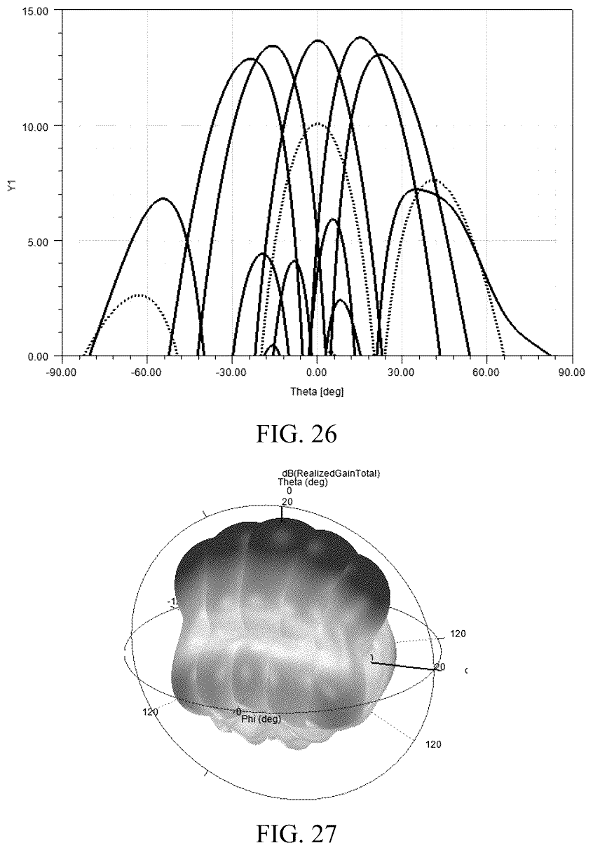

As shown in FIG. 25, experimental results demonstrate that a 1×4 phased array antenna module loaded with the arc-shaped metamaterial structure achieves a scanning angle of ±45° with a scanning gain loss of less than 1 dB. In contrast, as shown in FIG. 26, a planar metamaterial structure achieves a scanning angle of ±30° with a scanning gain loss of less than 1.6 dB. Additionally, the arc-shaped metamaterial structure exhibits lower sidelobe levels than the planar counterpart, improving overall antenna performance. The arc-shaped metamaterial structure increases antenna gain by approximately 3 dB across the coverage range.

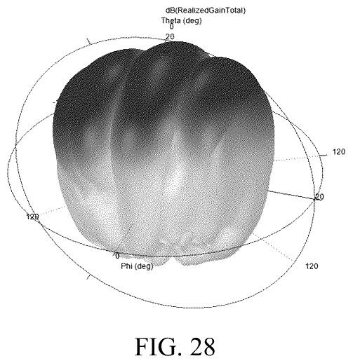

As shown in FIG. 27, the 3D radiation pattern of a 1×4 phased array antenna module loaded with an arc-shaped metamaterial structure demonstrates broader coverage compared to the planar structure shown in FIG. 28. This design reduces the required number of antenna modules by half, significantly simplifying the RF circuit's complexity and reducing its structural dimensions.

Compared to the prior art, the present disclosure offers at least the following advantages:

1. the phased array antenna module loaded with metamaterials (100) benefits from the refractive characteristics of the metamaterial structure, which increases the gain in the vertical (0-degree) direction. The arc-shaped metamaterial structure forms at least one arc-shaped concave surface, with each concave surface aligned with the corresponding millimeter-wave emission surface. During beam scanning, obliquely incident waves are vertically incident onto the concave surface, minimizing wave loss. Compared to planar metamaterial structures, the arc-shaped metamaterial structure not only improves gain but also expands the scanning angle, significantly reducing scanning loss.

2. the phased array antenna module loaded with metamaterials (100), including the millimeter-wave RF module (110) and arc-shaped metamaterial structure (120), can be securely fixed within the housing (200). The arc-shaped metamaterial structure (120), with its concave surfaces, aligns well with the contours of the 5G mobile device (10) housing. This configuration reduces the space required for equivalent gain performance, making the phased array antenna module better suited to the increasing integration demands of electronic devices.

The technical features of the embodiments described above can be combined in various ways. For simplicity, all possible combinations of these features are not explicitly described, but as long as the combinations do not result in contradictions, they are considered within the scope of this disclosure. The described embodiments represent several implementations of the present disclosure. While the descriptions are specific and detailed, they should not be construed as limiting the scope of the patent. Those skilled in the art can make modifications and improvements without departing from the spirit of the disclosure, and these should be considered within the scope of the protection. The scope of the patent is defined by the appended claims.

1. A phased array antenna module loaded with metamaterials, characterized by comprising:
a millimeter-wave RF module provided with at least one millimeter-wave emission surface; and
an arc-shaped metamaterial structure forming at least one arc-shaped concave surface, wherein each arc-shaped concave surface is aligned with a corresponding millimeter-wave emission surface;
each arc-shaped metallic pattern layer comprising multiple periodically distributed metallic unit structures, the number of arc-shaped metamaterial structures being multiple, the arc-shaped metamaterial structures being stacked, the metallic unit structures in each arc-shaped metallic pattern layer of the same arc-shaped metamaterial structure being of equal size; and
the metallic unit structures in each arc-shaped metallic pattern layer of multiple arc-shaped metamaterial structures being arranged in a one-to-one correspondence, with each metallic unit structure in the metallic pattern layers of multiple arc-shaped metamaterial structures stacked in a one-to-one correspondence, and the size of each metallic unit structure in the metallic pattern layers of adjacent arc-shaped metamaterial structures sequentially increases or decreases along the stacking direction.

2. The phased array antenna module loaded with metamaterials of claim 1, wherein the arc-shaped metamaterial structure comprises an arc-shaped dielectric substrate and two arc-shaped metallic pattern layers, one arc-shaped metallic pattern layer being formed on one surface of the arc-shaped dielectric substrate and the other arc-shaped metallic pattern layer being formed on the opposite surface of the arc-shaped dielectric substrate.

3. The phased array antenna module loaded with metamaterials of claim 2, wherein the arc-shaped dielectric substrate and the two arc-shaped metallic pattern layers are integrally formed; and/or
the number of arc-shaped metallic pattern layers is multiple; and/or
each arc-shaped metallic pattern layer is formed on the arc-shaped dielectric substrate through processes including LDS, FPC, LCP, MPI, ceramic, or metallic mesh.

4. The phased array antenna module loaded with metamaterials of claim 2, wherein the number of arc-shaped dielectric substrates is multiple, and the arc-shaped dielectric substrates are stacked.

5. The phased array antenna module loaded with metamaterials of claim 4, wherein the multiple arc-shaped dielectric substrates are laminated; and/or each arc-shaped dielectric substrate is made of at least one material selected from plastic, ceramic, or glass.

6. The phased array antenna module loaded with metamaterials of claim 5, wherein the materials of adjacent arc-shaped dielectric substrates are the same or different.

7. The phased array antenna module loaded with metamaterials of claim 2, wherein the spacing between metallic unit structures in each circular distribution is unequal.

8. The phased array antenna module loaded with metamaterials of claim 7, wherein the size of each metallic unit structure is 1/15 λ˜ 1/10 λ.

9. The phased array antenna module loaded with metamaterials of claim 8, wherein the spacing between adjacent metallic unit structures is 1/10 λ˜⅕ λ.

10. The phased array antenna module loaded with metamaterials of claim 7, wherein the spacing between metallic unit structures in the same circular distribution is unequal.

11. The phased array antenna module loaded with metamaterials of claim 10, wherein the size of each metallic unit structure in the metallic pattern layers of multiple arc-shaped metamaterial structures is different.

12. The phased array antenna module loaded with metamaterials of claim 11, wherein the size of metallic unit structures in the metallic pattern layers of multiple arc-shaped metamaterial structures sequentially increases or decreases along the stacking direction.

13. The phased array antenna module loaded with metamaterials of claim 1, wherein the number of millimeter-wave emission surfaces and the number of arc-shaped concave surfaces are multiple, and the multiple millimeter-wave emission surfaces are aligned with the multiple arc-shaped concave surfaces in a one-to-one correspondence.

14. An RF circuit, comprising a phased array antenna module loaded with metamaterials; wherein the phased array antenna module comprises:
a millimeter-wave RF module provided with at least one millimeter-wave emission surface; and
an arc-shaped metamaterial structure forming at least one arc-shaped concave surface, wherein each arc-shaped concave surface is aligned with a corresponding millimeter-wave emission surface;
each arc-shaped metallic pattern layer comprising multiple periodically distributed metallic unit structures, the number of arc-shaped metamaterial structures being multiple, the arc-shaped metamaterial structures being stacked, the metallic unit structures in each arc-shaped metallic pattern layer of the same arc-shaped metamaterial structure being of equal size; and
the metallic unit structures in each arc-shaped metallic pattern layer of multiple arc-shaped metamaterial structures being arranged in a one-to-one correspondence, with each metallic unit structure in the metallic pattern layers of multiple arc-shaped metamaterial structures stacked in a one-to-one correspondence, and the size of each metallic unit structure in the metallic pattern layers of adjacent arc-shaped metamaterial structures sequentially increases or decreases along the stacking direction.

15. The RF circuit of claim 14, wherein the operating frequency band of the phased array antenna module loaded with metamaterials is 10 GHz-300 GHz.

16. The RF circuit of claim 14, wherein the arc-shaped metamaterial structure comprises an arc-shaped dielectric substrate and two arc-shaped metallic pattern layers, one arc-shaped metallic pattern layer being formed on one surface of the arc-shaped dielectric substrate and the other arc-shaped metallic pattern layer being formed on the opposite surface of the arc-shaped dielectric substrate.

17. The RF circuit of claim 16, wherein the arc-shaped dielectric substrate and the two arc-shaped metallic pattern layers are integrally formed; and/or
the number of arc-shaped metallic pattern layers is multiple; and/or
each arc-shaped metallic pattern layer is formed on the arc-shaped dielectric substrate through processes including LDS, FPC, LCP, MPI, ceramic, or metallic mesh.

18. The RF circuit of claim 16, wherein the number of arc-shaped dielectric substrates is multiple, and the arc-shaped dielectric substrates are stacked.

19. The RF circuit of claim 16, wherein the multiple arc-shaped dielectric substrates are laminated; and/or each arc-shaped dielectric substrate is made of at least one material selected from plastic, ceramic, or glass.

20. A 5G mobile device, comprising a housing and a RF circuit;
wherein the RF circuit comprises a phased array antenna module loaded with metamaterials;
wherein the phased array antenna module comprises:
a millimeter-wave RF module provided with at least one millimeter-wave emission surface; and
an arc-shaped metamaterial structure forming at least one arc-shaped concave surface, wherein each arc-shaped concave surface is aligned with a corresponding millimeter-wave emission surface;
each arc-shaped metallic pattern layer comprising multiple periodically distributed metallic unit structures, the number of arc-shaped metamaterial structures being multiple, the arc-shaped metamaterial structures being stacked, the metallic unit structures in each arc-shaped metallic pattern layer of the same arc-shaped metamaterial structure being of equal size; and
the metallic unit structures in each arc-shaped metallic pattern layer of multiple arc-shaped metamaterial structures being arranged in a one-to-one correspondence, with each metallic unit structure in the metallic pattern layers of multiple arc-shaped metamaterial structures stacked in a one-to-one correspondence, and the size of each metallic unit structure in the metallic pattern layers of adjacent arc-shaped metamaterial structures sequentially increases or decreases along the stacking direction wherein the millimeter-wave RF module and the arc-shaped metamaterial structure are fixed within the housing.
